(19) United States
(12) Patent Application Publication
(10) Pub. No.: US 2012/0077134 A1
(43) Pub. Date: Mar. 29, 2012

(54) Candle Holder with Consistent Upright Candle

(76) Inventor: Damon L. Franklin, Queens Village, NY (US)

(21) Appl. No.: 13/086,271

(22) Filed: Apr. 13, 2011

Related U.S. Application Data
(63) Continuation of application No. 12/152,972, filed on May 20, 2008, now abandoned.
(60) Provisional application No. 61/070,810, filed on Mar. 27, 2008.

(51) Int. Cl. F21V 35/00; F23D 3/16

(52) U.S. Cl. 431/291; 431/289

(57) ABSTRACT

A candle holder is described having a fixture with a candle, the fixture pivotally positioned in a circular gimbal that is pivotally positioned in a cylindrical housing, an enclosure that is securely fastened with a proximal end of the housing.

a first upright position of the candle holder and a second inverted position of the candle holder.

The fixture includes an annular top and a counterbalance, the annular top adapted to receive the candle, and the counterbalance includes a groove on a top surface. The groove adapted to receive a magnetic disc. The candleholder has a first position in which the candle holder is upright along a longitudinal axis and a second position in which the candle holder is inverted about the longitudinal axis. The candle remains consistently upright in all orientations of the candle holder by virtue of gyroscopic mechanics and the counterbalance.

### CROSS REFERENCE TO RELATED APPLICATION

This application is a continuation of U.S. Ser. No. 12/152,972 filed May 20, 2008, which claims the benefit of U.S. Provisional Patent Application Ser. No. 61/070,810, filed on Mar. 27, 2008, each of which are expressly incorporated herein in its their entireties by reference thereto.

### BACKGROUND OF THE INVENTION

1. Field of the Invention

The invention relates to a candle holder, and more particularly, to a gyroscopic candle holder that has a fixture with a counter balance with a candle that maintains the candle in a consistently upright position.

2. Description of the Related Art

A variety of candle holders are known in the prior art. A candle holder generally has a body that receives the end of the candle. The candle holders with a glass cover are also known in the art. The disadvantage with these candle holders is that a user has to either tilt the candle holder or remove the candle from the candle holder to light the candle. Sometimes the user has to remove the glass cover to light the candle. In such a situation, the wax often undesirably drips out of the candle and the candle holder.

When the user carries the candle it is not possible to maintain the candle in a consistently upright position. When a candle is not in a consistently upright position, there is always a danger of the wax dripping over fingers or even the fingers getting burnt. Thus, the user has to walk very carefully while carrying the candle. Also, when the burning candle is kept in the holder on a table, care has to be taken that the burning candle does not accidentally fall on the table by a simple accidental pushing or shoving.

A candle holder is needed that can light a candle without removing the candle and that the candle maintains a consistently upright position whether it is carried, moved or rocked.

### SUMMARY OF THE INVENTION

A candle holder is described that comprises a counterbalance with a candle. The fixture is pivotally positioned in a circular gimbal that is pivotally positioned in a housing. The candle holder may also include an envelope/enclosure that is securely fastened with a proximal end of the housing. The candle holder has a first upright position and a second inverted position.

An aperture is defined in the housing to receive the gimbal and the counterbalance. The counterbalance has an upper annular portion and a lower portion. In one embodiment of the counterbalance, a recess is formed in the upper annular portion. A groove is adapted in a top surface of the counterbalance to receive a magnetic disc. The candle includes a wick, a wax ring, a wick tab, and a cover, which is mounted on the magnetic disc in the annular top of the counterbalance. The aluminum cover advantageously prevents spillage of wax when the candle is lighted.

The counterbalance is pivotally mounted in the gimbal with a first pair of pivot members adapted to rotate the counterbalance about an axis that is defined by the first pair of pivot members. The gimbal is pivotally mounted in the housing with a second pair of pivot members adapted to rotate the gimbal about an axis that is defined by the second pair of respective pivot members. The axis of the gimbal and the axis of the housing are preferably perpendicular with each other.

The candle is mounted in the annular top of the counterbalance such that the tab in the candle is placed on the magnetic disc. The magnetic forces of attraction securely hold the candle in the fixture. The candle holder has a first position in which the candle holder is upright along a longitudinal axis. The candle holder has a second position in which the candle holder is inverted along the longitudinal axis for removing and replacing the candle.

The candle is consistently upright in the first position and the second position. The gyroscopic mechanics employed in the construction of the candle holder and the counterbalance maintains the fixture, and thereby, the candle is consistently upright. The candle in the candle holder is consistently upright in all orientations of the candle holder. In another embodiment of the candle holder, a counterbalance with a candle is pivotally mounted in the housing. The candle remains approximately upright in all positions of the candle holder.

### BRIEF DESCRIPTION OF THE DRAWINGS

FIG. 1 is a front perspective view of a candle holder constructed in accordance with a preferred embodiment of the present invention;

FIG. 2 is an exploded front perspective view of the candle holder of FIG. 1;

FIG. 2A is a top perspective view of a counterbalance of the candle holder of FIG. 1;

FIG. 2B is a top perspective view of a counterbalance with a candle of the candle holder of FIG. 1;

FIG. 3 is an exploded front perspective view of a candle in accordance with a preferred embodiment of the present invention;

FIG. 4 shows a method of mounting the candle in an annular top of a counterbalance;

FIG. 5 shows a method of mounting the counterbalance in a gimbal of the candle holder of FIG. 1;

FIG. 6 shows a method of mounting the gimbal with the counterbalance in a housing of the candle holder of FIG. 1;

FIG. 7a shows a first upright position of the candle holder of FIG. 1 in accordance with the preferred embodiment of the present invention;

FIG. 7b shows a second inverted position of the candle holder of FIG. 1 in accordance with the preferred embodiment of the present invention;

FIGS. 8 a-c show positions of the candleholder of FIG. 1 while the orientation is changed from the first position to an intermediate position, and from the intermediate position to the second position;

FIG. 9 shows a perspective of another embodiment of the candle holder of the present invention; and

FIG. 10 shows an exploded front perspective view of the candle holder of FIG. 9.

### DESCRIPTION OF THE PREFERRED EMBODIMENT OF THE INVENTION

Although specific terms are used in the following description for the sake of clarity, these terms are intended to refer only to a particular structure of the invention selected for illustration in the drawings, and are not intended to define or limit the scope of the invention.

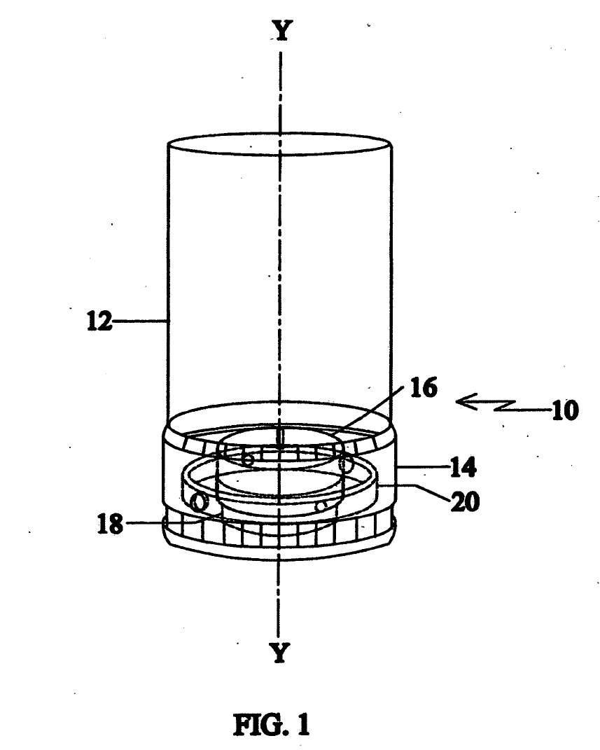

Referring to FIG. 1, a candle holder 10 in accordance with a preferred embodiment of the present invention is shown. The candle holder 10 includes an enclosure or cover 12 and housing 14. The glass enclosure 12 is securely coupled with the housing 14. The housing 14 includes a candle 16 that is securely positioned in a counterbalance 18. The counterbalance 18 is pivotally securely positioned in a gimbal 20 that is pivotally securely positioned in the housing 14. The candle holder 10 has a first upright position and a second inverted position.

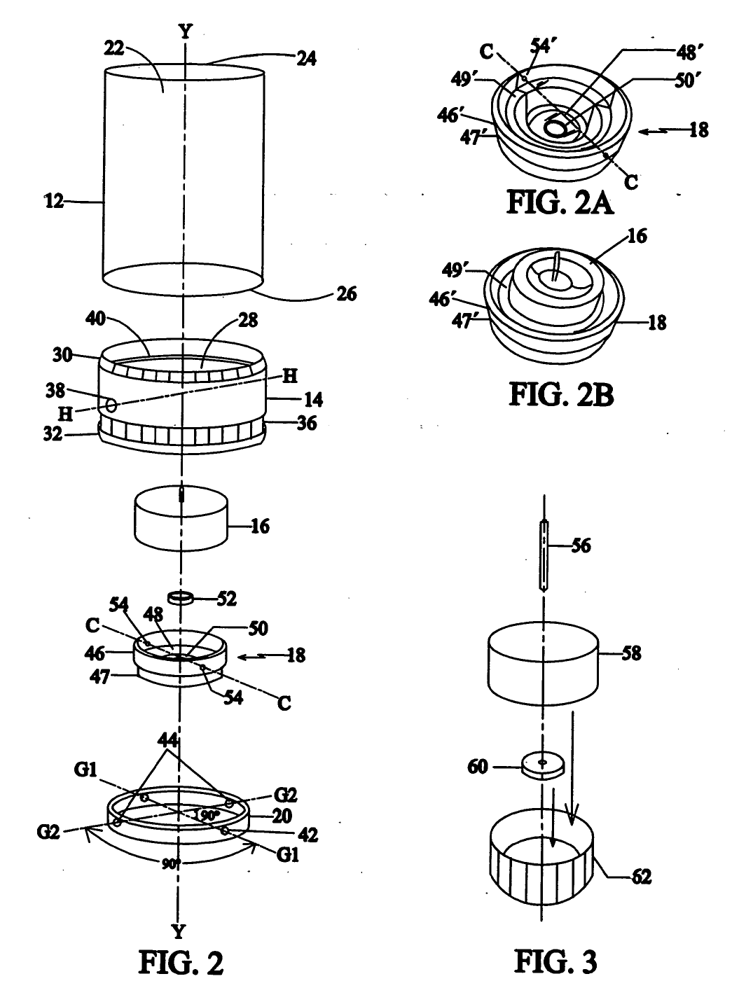

Referring to FIG. 2 an exploded view of the candle holder in accordance with a preferred embodiment of the present invention is shown. The glass envelope 12 has an aperture 22 that is defined by an open proximal end 24 and an open distal end 26 along a longitudinal axis-Y. The envelope or cover 12 can be, but not limited to, a translucent glass or acrylic cylinder of varying colors and heights, bottle shaped glass or acrylic enclosures of various colors and heights, or a lantern shaped enclosure.

The housing 14 is a cylindrical metallic construction. The housing 14 includes a through aperture 28 that is defined approximately centrally in the housing 14 by a proximal end 30 and a distal end 32 along the longitudinal axis-Y. An outer peripheral portion of housing 14 includes a groove 36 in proximity with the distal end 32. The groove preferably includes a plurality of holes. In this preferred embodiment, the housing 14 also includes a pair of opposed through holes 38 on the outer periphery of the housing 14. The first pair of opposed holes 38 define an axis of housing-H. In this preferred embodiment, the drilled holes 38 of ⅛″ are positioned approximately ⅝″ up on the housing 14.

The aperture 28 includes an indentation 40 along an inner periphery in proximity with proximal end portion 30 of housing 14. The diameter of the aperture 28 is preferably approximately greater than the diameter of envelope 12. In this preferred embodiment, the drilled holes of ⅛″ are positioned approximately ⅝″ up on the housing 14. The height of the housing 14 is approximately ⅓ the height of the enclosure 12.

The gimbal or ring 20 includes a first pair of opposed through holes 42 and a second pair of opposed through holes 44 on an outer periphery of the gimbal 20. The first pair holes 42 defines a first axis of gimbal-G1 and the second pair of holes 44 defines a second axis of gimbal-G2. The first axis of gimbal-G1 and the second axis of gimbal-G2 intersect with each at 90°. Each of the holes 42 and 44 is separated from the adjacent holes by approximately 90°.

The counterbalance 18 has an annular upper portion 46 and lower portion 47. The annular upper portion 46 forms a seating for the candle 16. An approximately flat top surface 48 of the lower portion 47 has a circular groove 50 that is adapted to receive a magnetic disc 52. Candle 16 is securely mounted in the annular top 46 so that a bottom surface of the candle 16 is in contact with top surface of the counterbalance 48. In this preferred embodiment, the magnetic disc 52 is a Neodymium disc magnet with ⅜″ diameter and 1/16″ thickness. The counterbalance 18 includes a pair approximately identical to opposed hole 54 on an outer periphery of the top annular gimbal 20. The pair of opposed holes 54 define an axis of counterbalance-C.

Referring to FIGS. 2A and 2B, another embodiment of the counterbalance 18 is shown. The counter balance 18 includes annular upper portion 46′ and lower portion 47.′ The annular upper portion 46′ forms a recess 49′ that is advantageously used to avoid wax spillage. An approximately flat top surface 48′ of the lower portion 47′ defines an approximately circular groove 50′ that is adapted to receive the magnetic disc 52. The pair of opposed holes 54′ define an axis of counterbalance-C.

Referring to FIG. 3, the candle 16 includes a candle wick 56, a wax ring 58, a wick tab 60, and an aluminum cover or enclosure 62. The wick tab or sustainer 60 is a round flat metal disc with a hole in the middle for the wick 56. The tab 60 secures the end of the wick 56. The candle 16 with the wick 56 and tab 60 is securely positioned in the aluminum enclosure 62. The aluminum cover advantageously prevents spillage of wax when the candle is lighted.

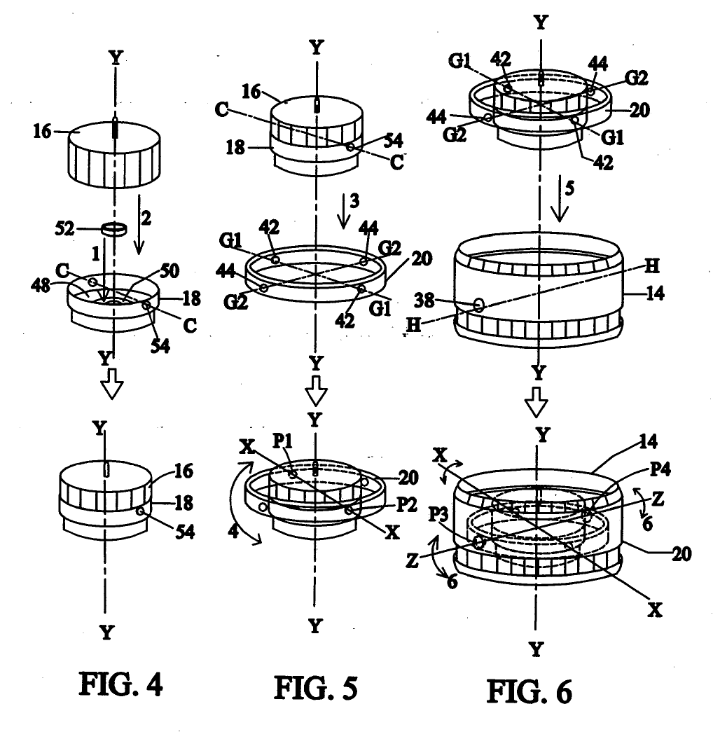

Referring to FIGS. 4, 5 and 6, a method of assembly of the candle holder 10 is described. In a first step, the magnetic disc 52 is positioned in the predefined circular groove 50 in the counterbalance 48 as indicated by arrow ‘1’. The thickness of the disc 52 is such that the disc 52 and a top surface of the counter weight 48 form an approximately flat surface when the disc 52 is completely inserted in the circular groove 50 in the counterweight 48.

In a second step, the candle 16 is inserted in the counterbalance 18 along axis-Y as indicated by arrow ‘2’. In the second step, a bottom surface of the candle 16 rests on the approximately flat surface defined by the magnetic disc 52 and a top portion of the counterbalance 18. In step 3, the counterbalance 18 with the candle 16 is positioned in the gimbal 20 along axis-Y. Arrow ‘3’ indicates the direction of insertion of the counterbalance 18.

In the third step, the counterbalance 18 is mounted in the gimbal 20 preferably with a first pair of pivot members P1 and P2. The first pair of pivot members defines a first pivotal axis-X. The first pivotal axis-X passes through the center of each of opposed hole 54 and opposed hole 42. The counterbalance 18 is mounted in the housing 14 so that the first pivotal axis-X is collinear with the axis of counterbalance-C and the first axis of gimbal-G1.

In this preferred embodiment, a pair of steel bearings acts as pivot members P1 and P2 such that the pair of bearings sits securely between the holes 54 of the counterbalance 18 and respective holes 44 of the gimbal 20. It is, however, understood that the pivot members P1 and P2 can be any pivot members, known in the art. For example, the pivot members may be a pair of shafts or a pair of pins. The first pair of pivot members defines an axis-X that passes through the centre of holes 44 and 55. It is, however, understood that axis-X and axis-B (FIG. 2) are approximately collinear.

The counterbalance 18 may be rotated about the axis-X in clockwise and counterclockwise directions relative to the gimbal 20 in the space defined by the perimeter of the gimbal 20. The direction of movement of the counterbalance 18 is indicated by a curved arrow 4. A set of ball bearings are preferably adapted in the drilled holes 44 and 54 to avoid friction.

In step four, the gimbal 20 with the counterbalance 18 is positioned in the housing 14 along axis-Y in a direction indicated by arrow 5. Gimbal 20 is mounted in the housing 14 preferably with a second pair of pivot members P3 and P4. The second pair of pivot members defines a second pivotal axis-Z. The second pivotal axis-Z passes through the center of holes 38 and 44. The gimbal 20 is positioned in the housing 14 so that the second axis of gimbal-G2 and the axis of housing-H are collinear with the second pivotal axis-Z.

In this preferred embodiment, a pair of steel bearings acts as pivot members P3 and P4 such that the pair of bearings sits securely between the holes 44 of the gimbal 20 and respective holes 38 of the housing 14. The gimbal 20 is rotatable relative to the housing about the axis Z. The gimbal 20 has a freedom of rotation about the axis-Z in clockwise and counterclockwise directions as indicated by arrow 6. A set of ball bearing is preferably adapted in the respective holes 38 and 42. Enclosure 12 is preferably fastened with the housing 14 after the complete assembly of the housing 14. The pivotal axis-X is preferably always perpendicular to the pivotal axis-Y.

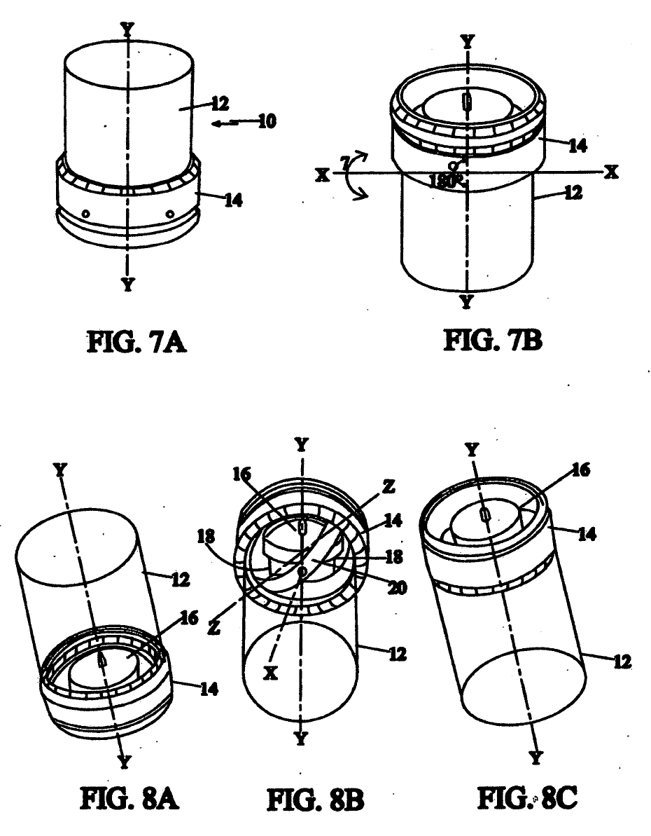

Referring to FIGS. 7a and b, in the first position, the candle holder 10 is upright along the Y-axis. Enclosure 12 and housing 14 are approximately longitudinally aligned along the vertical axis-Y. In the second position, the candle holder 10 is inverted along the Y-axis. The second position of holder 10 is achieved by preferably rotating the holder 10 about X-axis in a clockwise or counterclockwise direction as indicated by arrow 7. It is understood, however, that the candle holder 10 can be inverted about any other suitable axis to attain the second position. The candle holder 10 is rotated by approximately 180° from the first position to the second position.

Referring to FIG. 8, the first position, an intermediate position and the second position of the candle holder 10 are shown. Candle 16 remains consistently upright while rotating the candle holder 10. In an intermediate position, the orientation of the gimbal 20 and the housing 14 is changed to maintain the candle 16 approximately upright. The candle 16 remains consistently upright by virtue of the combined effect of the counterbalance 48 and the gyroscopic arrangement of the fixture 18, gimbal 20, and housing 14.

The counterbalance 18 is heavier than the candle 16 that is mounted on the top of the counterbalance 48. When the orientation of the housing 14 is changed from the first position to any random position, the counterbalance 48 has the tendency to move in the direction of earth due to gravity which tends to move the fixture 18 about the axis-X or the axis of gimbal which keeps the candle 16 upright.

The rotation of the counterbalance 18 about the axis of the gimbal-X advantageously rotates the gimbal 20 about the axis-Z or the axis of housing relative to the housing 14. The tendency of the candle 16 to remain upright is supported by the motion of the fixture 18 and the gimbal 20 relative to the housing 14. The vertical axis-Y is preferentially always perpendicular to the axis of gimbal-X and axis of housing-Z.

The earth's natural gravity keeps the counterbalance 48 centered and the candle 16 upright within the rotating enclosure 12. The gimbal 20 allows counterbalance 48 to continue the lowermost position while the orientation of gimbal 20 and the housing 14 is being changed. The embedded neodymium magnet within the counterbalance 18 advantageously holds the tab 60 of the candle 16 by the magnetic force of attraction between the tab 60 and the magnet.

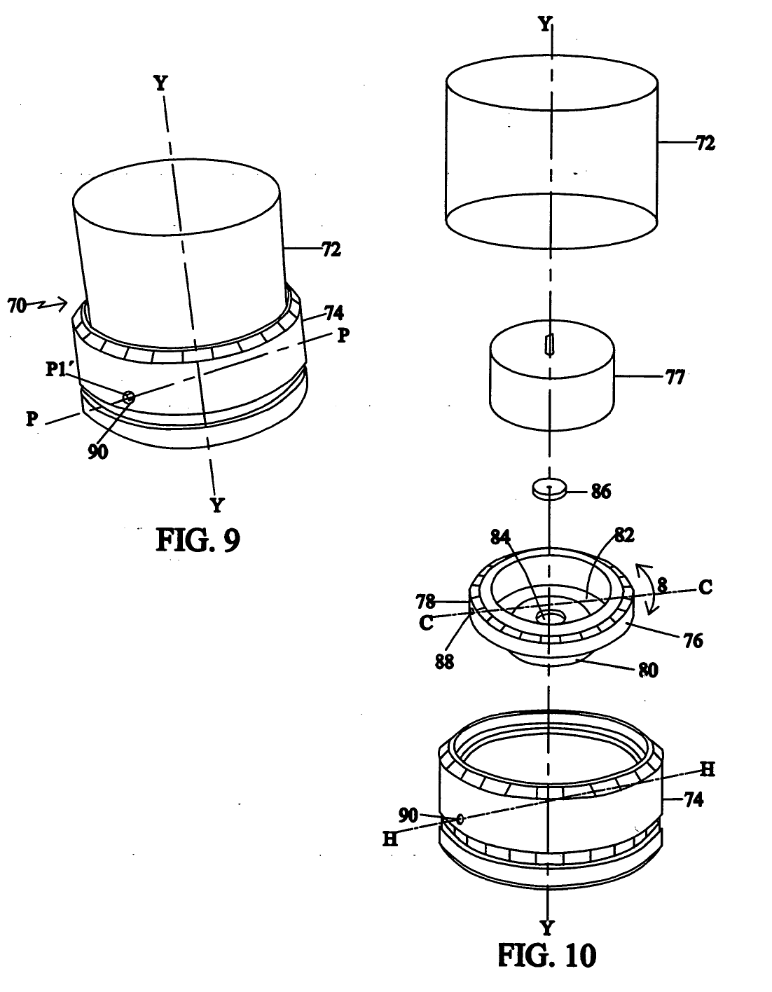

Referring to FIGS. 9 and 10, in another embodiment, the candle holder 70 includes an envelope 72 that is securely coupled with housing 74. A counterbalance 76 is pivotally securely positioned in housing 74. A candle 77 is securely positioned in the counterbalance 76. Candle holder 70 has a first upright position and a second inverted position along axis-Y.

The counterbalance 76 includes an annular upper portion 78 and lower portion 80. Annular upper portion 78 forms a seating for the candle 77. An approximately flat top surface 82 of the lower portion 80 defines an approximately circular groove 84 that is adapted to receive a Neodymium magnetic disc 86.

Candle 77 is preferably securely mounted in the annular portion 78 so that a bottom surface of the candle 77 is in contact with top surface 82 of the counterbalance 76. In this preferred embodiment, the magnetic disc 86 is with ⅜″ diameter and 1/16″ thickness. The annular upper portion 78 includes a pair of opposed holes 88 that defines the axis of counterbalance-C.

The counterbalance 76 is mounted in the housing 74 preferably with a pair of pivot members. In this embodiment, a pair of steel bearings acts as pivot members such that the pair of bearings sits securely between the holes 88 of the counterbalance 76 and respective holes 90 of housing 74. It is, however, understood that the pivot members can be any pivot members, known in the art, such as, a pair of shafts or a pair of pins.

An axis-P passes through the center of holes 88 and 90, and the pair of pivot members. Counterbalance 76 is rotatable about the axis-P in clockwise and counterclockwise directions relative to the housing 74 in the space defined by housing 74. The direction of rotation of the counterbalance 76 is indicated by a curved arrow 8.

The candleholder 70 is rotated about axis-H from the first upright position to the second inverted position. The candle 77 remains vertical by virtue of the counterbalance 76 that rotates about axis-P to retain the candle approximately upright in the first position, any intermediate position, and the second positions. The candle 77 in the candleholder 70 remains consistently upright in all orientations of candleholder 70.

Referring to FIGS. 1-9, in operation, the candle holder 10 is initially in the first position. The candle holder 10 is preferably positioned on an approximately flat platform, such as, a table, a corner or a desk. A candle 16 is then inserted in the counterbalance 18, or the existing candle 16 in the counterbalance 18 is replaced with a new candle 16. The candle 16 is then lit and the candle holder 10 is then returned to the first upright position.

While inverting the holder 10, the gimbal 20 rotates about its axis-X and the counterbalance 18 rotates towards the ground due to gravity. By the virtue of the motion of the gimbal 20 and the gravitational forces of attraction, the candle 16 remains consistently upright. The candle 16 is then lighted. The candle 16 is then inverted back to the first position and is seated on the platform with the bottom portion of the housing 14.

The candle 16 remains consistently upright even if the holder 10 is tilted due to an accident. This avoids spillage of molten and hot wax from the candle 16 which may result in an accident. The candleholder 10 may be moved from one point to another even if the candle 16 is lighted. The tab 60 advantageously secures the candle 16 in the magnetic counterbalance 18. Indentation 40 provides a seating for the envelope 12. The magnetic counter balance 18 holds the magnetic disc 52 in position. The holes in the outer peripheral portion of the housing 14 are for ventilation and introduce fresh air in housing 14 and envelope 12.

The invention is described in detail with reference to specific structure embodying the invention, while it should be understood that it will be apparent to those skilled in the art that various modifications and rearrangements in the parts may be made without departing from the spirit and scope of the present invention.

What is claimed is:

1. A candle holder comprising:
a counterbalance, the counterbalance pivotally positioned in a gimbal that is pivotally positioned in a cylindrical housing;
an envelope that is securely fastened with a proximal end of the housing;
a first pair of pivot members that defines a first pivotal axis, each pivot member connecting the counterbalance and the gimbal; and
a second pair of pivot members that defines a second pivotal axis, each pivot member connecting the gimbal to the housing.

2. The candle holder of claim 1, wherein the counterbalance includes an annular upper portion and a lower portion, the annular upper portion is adapted to receive a candle, the lower portion includes a top surface that has a circular groove that is adapted to receive a magnetic disc.

3. The candle holder of claim 1, wherein the gimbal includes a first pair of opposed holes and a second pair of opposed holes, the first pair of opposed holes in line with the first pivot axis and the second pair of opposed holes in line with the second pivot axis.

4. The candle holder of claim 1, wherein the housing includes a pair of opposed through holes on an outer periphery of the housing, the pair of opposed holes in line with the second pivot axis.

5. The candle holder of claim 1, wherein the housing includes an aperture with a diameter that is approximately greater than a diameter of the envelope.

6. The candle holder of claim 1, wherein the housing includes an indentation in proximity with a proximal end along an inner periphery of the housing, the indentation is adapted to provide a seating to the bottom end of the envelope.

7. The candle holder of claim 1, wherein the first pivotal axis and the second pivotal axis intersect with each other at 90°.

8. The candle holder of claim 1, further comprising a candle attached to the counterbalance, wherein the candle is maintained in an upright position when the candle holder is rotated.

9. The candle holder of claim 8, wherein the candle is removable and replaceable when the candle holder is positioned with the distal end of the housing above the envelope.

10. The candle holder of claim 8, wherein the candle includes a wax ring having a wick and a wick tab, the wax ring positioned in a cylindrical cover to prevent spillage of wax.

11. The candle holder of claim 8, wherein the candle includes a tab adapted to secure to a magnetic disc using magnetic forces of attraction.

12. A candle holder comprising:
a counterbalance pivotally positioned within a cylindrical housing;
an envelope securely fastened with a proximal end of the housing and
a pair of pivot members between the counterbalance and housing that defines a pivotal axis;
a first upright position of the candle holder; and
a second inverted position of the candle holder.

13. The candle holder of claim 12, wherein the counterbalance includes an annular upper portion and a lower portion, the annular upper portion is adapted to receive the candle, the lower portion includes a top surface that has a groove, the groove is adapted to receive a magnetic disc.

14. The candle holder of claim 12, wherein the housing includes a pair of opposed through holes on an outer periphery of the housing, the pair of opposed holes defines an axis of housing to pivot the counterbalance in the housing.

15. The candleholder of claim 12, wherein the counterbalance is mounted in the housing with the pair of pivot members along the pivotal axis that is collinear with the axis of counterbalance and the axis of housing.

16. A candle holder comprising:
a counterbalance including a lower portion and an annular upper portion, the lower portion including a magnet and the annular upper portion configured to receive a candle;
a candle comprising a tab removably secured to said magnet in said lower portion of said counterbalance;
said counterbalance pivotally positioned in a circular gimbal that is pivotally positioned in a cylindrical housing;
a first pair of pivot members that defines a first pivotal axis for said counterbalance relative to said gimbal; and
a second pair of pivot members that defines a second pivotal axis for said gimbal relative to said cylindrical housing;
wherein said counterbalance and candle are maintained in an upright position when said cylindrical housing is inverted.

17. A candle holder with a pivotally secured housing comprising:
a generally cylindrically shaped housing having an open proximal end, an open distal end, and an aperture;
a counterbalance configured to hold a candle, said counterbalance configured to fit within said aperture of said housing and pivotally secured to said housing;
a generally cylindrically shaped enclosure comprising an open proximal end, an open distal end, and an aperture, said enclosure secured to said proximal end of said housing at an end;
wherein, said counterbalance of said candle holder pivots about an axis when said candle holder is rotated generally perpendicular to the pivot axis of said counterbalance.

18. The candle holder according to claim 17, wherein said counterbalance is pivotally secured to said housing by a pair of pivot members.

19. The candle holder according to claim 18, wherein said pivot members are one from the group consisting of ball bearings, shafts, and pins.

20. The candle holder according to claim 17, wherein said counterbalance is approximately centrally located between said proximal end and said distal end of said housing.

21. The candle holder according to claim 17, wherein said counterbalance further comprises a circular groove for a magnet.

22. The candle holder according to claim 21, wherein said counterbalance further comprises a magnet in said circular groove.

23. The candle holder according to claim 17, wherein said housing further comprises a groove on the outer periphery.

24. The candle holder according to claim 23, wherein said groove further comprises a plurality of venting holes through one side of said housing.

25. The candle holder according to claim 17, wherein said housing further comprises a plurality of venting holes through one side of said housing.

26. The candle holder according to claim 17, wherein the outer diameter of said housing is greater than the outer diameter of said enclosure.

27. The candle holder according to claim 17, further comprising a candle comprising a tab adapted to secure to a magnetic disc using magnetic forces of attraction.
